(19) United States
(12) Patent Application Publication
(10) Pub. No.: US 2006/0093702 A1
(43) Pub. Date: May 4, 2006

(54) Encapsulation mold assembly and interchangeable cartridge

(76) Inventors: Keith C. Andersen, Hockessin, DE (US); John A. Foltz, Wilmington, DE (US); Gilbert Barfield, Carrabelle, FL (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/191,810

(22) Filed: Jul. 28, 2005

Related U.S. Application Data
(60) Provisional application No. 60/592,002, filed on Jul. 28, 2004.

(51) Int. Cl. B29C 45/42

(52) U.S. Cl. 425/556

(57) ABSTRACT

A retractable pin injection molding assembly includes a cartridge comprising a mold cavity, a cavity sleeve to accept water and vacuum lines at the back of the mold, an ejector assembly, and a pin connection block with a groove for a locking slide, so that the cartridge may be changed rapidly without disassembling the injection molding assembly. Also provided is a mechanism for continuously adjusting the length of the ejector pins within the mold cavity.

### CROSS-REFERENCE TO RELATED APPLICATIONS

This application claims priority under 35 U.S.C. § 119(e) based on U.S. Provisional Application No. 60/592,002, filed Jul. 28, 2004, which is incorporated herein by reference in its entirety.

### BACKGROUND OF THE INVENTION

1. Field of the Invention

The present invention relates to the field of injection molding, and, in particular, to an injection mold assembly featuring interchangeable encapsulation mold cartridges.

2. Description of the Related Art

One or more patents are cited in this description in order to more fully describe the state of the art to which this invention pertains. The entire disclosure of each of these patents and publications is incorporated by reference herein.

When an object having two or more layers is made by injection molding, one component of the assembly may be fully covered or encapsulated by another layer of a thermoplastic material. To achieve this structure, the inner component is held in place inside the larger mold, typically by a set of pins, and then released by retracting the pins as the filling operation for the second layer is nearing completion. The release allows the thermoplastic material to flow over the pins used for holding the inner component and produce seamless welds. Injection molds used in operations of this type are complex. Moreover, when the inner component and the layered component are produced on the same machine, the mold must be removed from the molding machinery and disassembled to change from one size or type of product to another.

In today's manufacturing environment, however, flexibility and minimal downtime are key elements of productivity and profitability. It follows that cycle time reduction and quick mold changeover are desirable features in an injection molding facility.

Therefore, there is a need in the art for an injection mold assembly that increases the flexibility of injection molding machinery and that reduces cycle time and downtime for equipment changeovers.

### SUMMARY OF THE INVENTION

Accordingly, it is an object of the invention to provide an injection mold assembly that increases the flexibility of injection molding machinery and that reduces cycle time and downtime for equipment changeovers.

In order to achieve the above and other objects of the invention, a retractable pin injection molding assembly is provided. The retractable pin injection molding assembly includes a cartridge comprising a mold cavity, a cavity sleeve to accept water and vacuum lines at the back of the mold, an ejector assembly, and a pin connection block with a groove for a locking slide, so that the cartridge may be changed rapidly without disassembling the injection molding assembly. Also provided is a mechanism for continuously adjusting the length of the ejector pins within the mold cavity.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1A is a plan view of the inner face of a retractable pin injection mold assembly of the prior art. FIG. 1B is a side view of two unengaged complementary halves of a retractable pin injection mold assembly of the prior art.

FIG. 2 is a fragmentary cross-section of a retractable pin injection mold assembly of the prior art.

FIG. 3A is a top plan view and FIG. 3B is a side view of a retractable pin cavity.

FIG. 4A is a top plan view, FIG. 4B is a side plan view, and FIG. 4C is a bottom plan view of a vacuum bushing.

FIG. 5A is a side plan view and FIG. 5B is a top plan view of a vacuum bushing cap.

FIG. 6A is a top plan view, FIG. 6B is a side plan view, and FIG. 6C is a bottom plan view of a cavity sleeve of the invention.

FIG. 7A is a top plan view, FIG. 7B is a side plan view, and FIG. 7C is a bottom plan view of a vacuum bushing sleeve.

FIG. 8A is a side plan view and FIG. 8B is a top plan view of a connection stud for a coolant or vacuum line.

FIG. 9A is a side plan view and FIG. 9B is a top plan view of a pin holder.

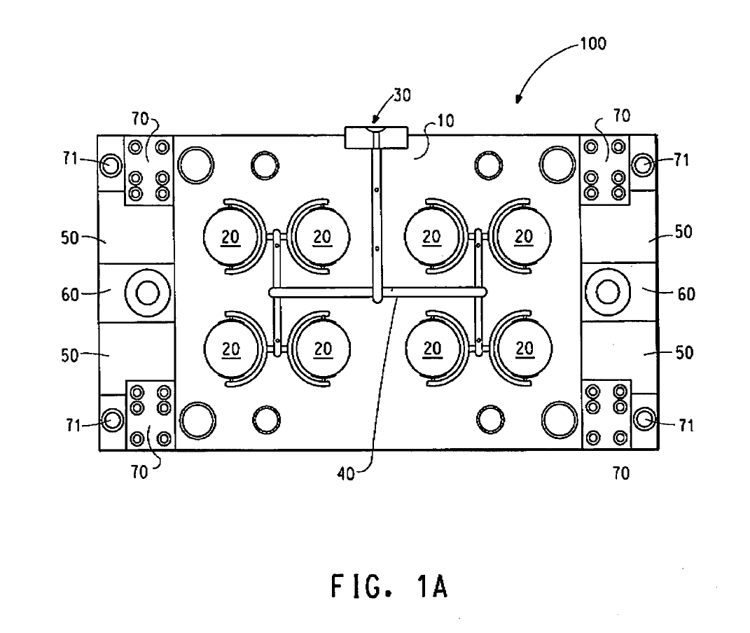

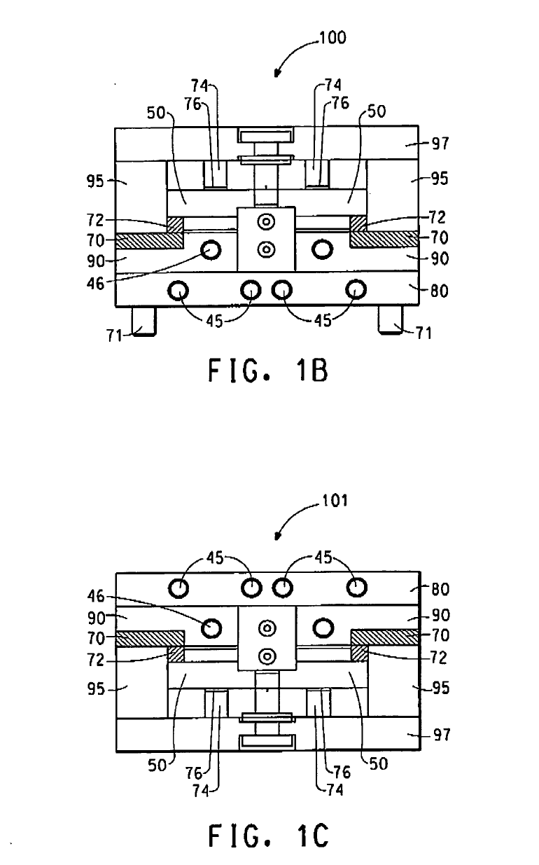

FIG. 1OA is a side plan view and FIG. 1OB is a top plan view of a pin connection block of the invention.

FIG. 11A is a side plan view and FIG. 11B is a top plan view of a locking slide.

FIG. 12A is a top plan view and FIG. 12B is a side plan view of a stop block. FIG. 12C is a side plan view of a stop stud.

FIG. 13 is a cross section of an interchangeable cartridge assembly of the invention.

FIG. 14 is a fragmentary cross section of an encapsulation mold assembly of the invention.

### DETAILED DESCRIPTION OF THE INVENTION

The definitions herein apply to the terms as used throughout this specification, unless otherwise limited in specific instances.

The term “forward”, as used herein, refers to the direction in which the two halves of an injection mold move when they are brought together.

The term “rearward”, as used herein, refers to the direction in which the two halves of an injection mold move upon separation.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

Referring now to the drawings, wherein like reference numerals designate corresponding structure throughout the views, and referring in particular to FIG. 1A, a retractable pin injection mold assembly 100 of the prior art includes a body 10 in which one or more mold cavities 20 are present. Molten thermoplastic material enters the body through an inlet port 30 and is led through the body by a system of tubes known as runners 40 to the mold cavities 20. The retractable pin injection mold assembly 100 also includes one or more ejector assemblies 50, one or more cylinder assemblies 60, and one or more stop caps 70 for stopping the forward movement of the ejector assembly or assemblies 50. Ejector assembly 50 not only ejects the molded part, but also holds the article to be encapsulated in its proper position during the injection cycle. Structures for mating the mold with its complementary counterpart may include aligning dowels 71, receiving holes and the like.

Referring now to FIG. 1B, retractable pin injection mold assembly 100 and its mate 101 also include cavity plates 80 for retaining the cavities 20 and containing the runner system 40. Cavity plates 80 may have, in their interior, lines or tubes 45 which allow a coolant, typically water, to circulate around the cavity 20.

Also included in the injection mold assemblies 100 and 101 are backup or support plates 90, to prevent the cavities 20 on each of the mated mold assemblies 100 and 101 from being pushed apart due to the tremendous pressures applied during the injection of the thermoplastic material. The backup plates 90 also include the connections 46 for the vacuum lines.

Retractable pin injection mold assembly 100 and its mate 101 also include parallel assemblies 95 for attaching the cavity plates 80 and backup plates 90 to the mounting plate assemblies 97. These parallels 95 create an opening or “box” which allows the ejector assembly 50 to move forward and backward as the injection cycle requires.

Still referring to FIG. 1B, the cylinder assemblies 60 are attached to the ejector assemblies 50 and the mounting plates 97. The cylinder assemblies 60, which move the ejector assembly 50 forward and backward, usually include hydraulic cylinders; however, mechanical devices, for example wedges attached to a driving motion such as servo motor, may also be suitable for this purpose.

The mold assemblies 100 and 101 further include stop caps 70 and stop blocks 72 for stopping the forward motion of the ejector assembly 50 at the proper location. Also included are stop rails 74 and stop pads 76 for stopping the rearward motion of the ejector assembly 50 at the proper location.

Those of skill in the art are aware that the mold assemblies 100 and 101 may also contain additional components such as support columns, dowels, nozzle seats, and the like, that are not depicted in FIGS. 1A and 1B.

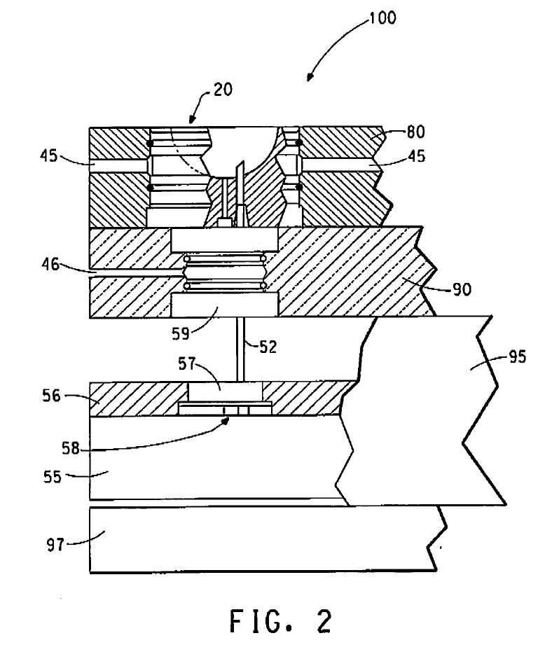

Referring now to FIG. 2, a retractable pin injection mold assembly 100 and 101 of the prior art is operated in the following manner: With the mold halves 100 and 101 separated, articles to be encapsulated (referred to hereinafter as “cores”) are loaded into the mold. The core holding pin or pins 52 may be forward or retracted during this operation. The complementary halves of the mold 100 and 101 are then closed and clamped together. If the core holding pins 52 are already forward, the core is located in its proper position due to the limiting motion of the stop blocks 72. If the pins 52 were retracted, the pins now move forward to position the core. Injection of the encapsulation material begins. The screw position and injection pressures of the molding machine are monitored. A vacuum is applied to the mold cavity 20 to remove gasses and facilitate the flow of the thermoplastic material. When the mold is filled with a certain amount of thermoplastic material, the core holding pins 52 are retracted to a position determined by the stop pads 76, leaving the core supported by the already injected material. Injection of the thermoplastic material continues until the mold is full and the core is completely encapsulated. Once the injected material is cooled sufficiently the mold is opened and the part is ejected.

Still referring to FIG. 2, an ejector assembly 50 comprises the core holding pins 52 and the runner ejector pins (not shown) as well as an ejector plate 55 which is attached to the cylinder assembly 60 and a pin retainer plate 56 which is adapted to receive a pin holder 57. The pin holder 57, which may feature a retaining flange 58, holds the pins 52 and keeps them in proper orientation. FIG. 2 also shows the connection of the vacuum to the cavity 20 via a vacuum bushing 59.

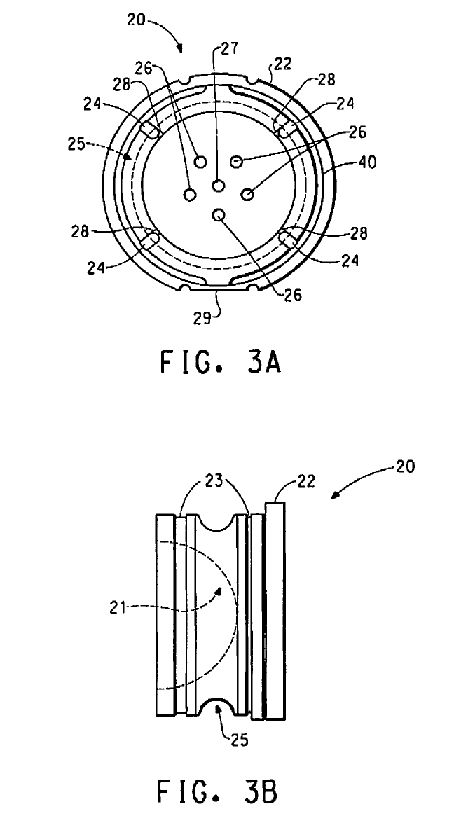

Referring now to FIGS. 3A and 3B, in a conventional retractable pin mold 100, and in a retractable pin mold 500 of the invention, the cavities 20 define a space that is the mold form 21. The mold form 21 is the negative image of the shape and size that is desired for the layered injection molded article. The cavity 20 is inserted into the cavity plate 80 and retained by a flange 22, or, alternatively, a retaining ring or screws. The outside diameter of the cavity 20 has one or more grooves 23 for O-rings. Also formed on the outside of the cavity 20 is a coolant groove 25, so that the layered article can be cooled by circulating water, for example, thereby decreasing cycle time. The cavity 20 also has one or more holes 26 for the core holding pins 52, and one or more holes 27 for vent pins. Inlets 24 for feed runners 25 allow the hot thermoplastic material to enter the mold form 21 through one or more outlets or gates 28. The cavity 20 also has a locating flat 29 or other means to align the inlets 24 and pin holes 26 and 27 properly when the cavity 20 is installed into the mold 100 or 500.

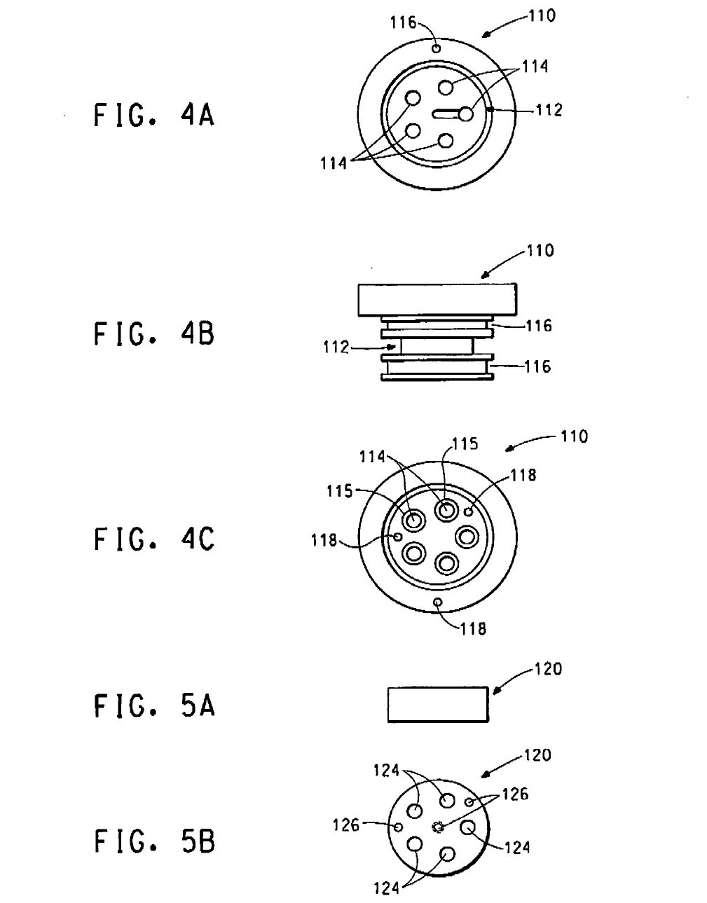

Referring now to FIGS. 4A, 4B, and 4C, a vacuum bushing 110 is used in a conventional retractable pin mold 100 and in a retractable pin mold 500 of the invention. As the thermoplastic material is injected into the cavity 20, the air inside the cavity 20 as well as any gasses generated by the heated thermoplastic material is removed by displacement. One or more of the core holding pins 52 and vent pins (not shown) may have vents along its periphery to allow these gasses to escape the cavity 20. To improve the efficiency of the displacement and to further assist in filling the mold, it is also common to pull a vacuum around one or more of the core holding pins 52 and vent pins. This is accomplished by having an assembly behind the cavity that comprises, for example, a vacuum bushing 110. The vacuum bushing 110 comprises a groove 112 for vacuum that intersects the pin holes 114. The pin holes may also be fitted with pockets 115 for O-rings, as shown in FIG. 4C. One or more grooves 116 for O-rings or similar sealing devices seal the bushing 110 against the back of the cavity 20 and around the pins. One or more aligning dowels 118 may also be included in the bushing 110. A vacuum may be pulled between the O-ring seals at grooves 116. The vacuum is transmitted to the cavity 20 via the core holding pins 52 and vent pins. After injection it is also common to pressurize the cavity 20 by admitting gas through this assembly to assist in the ejection of the part.

Referring now to FIGS. 5A and 5B, each vacuum bushing 110 may be fitted with one or two vacuum bushing caps 120. The vacuum bushing caps 120 may be made of any suitable material. A preferred material is 416 S.S. The vacuum bushing cap 120 is provided with holes 124 and dowels 126 to match the holes 114 and dowels 118 of the vacuum bushing 110.

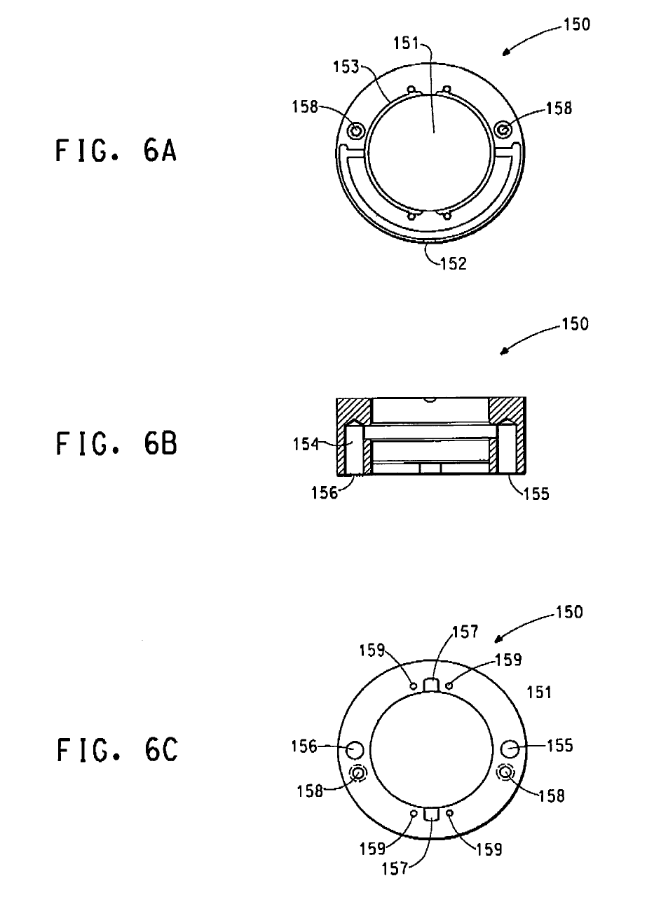

Turning now to FIGS. 6A, 6B, and 6C, a cavity sleeve 150 is provided by the present invention. The cavity sleeve 150 holds the cavity 20 in proper orientation, seals around the cavity 20, circulates coolant around the cavity 20, allows runner pins 52 to pass through its body, connects the runner 40 of the mold to the cavity 20, and has an outside diameter that is smooth or otherwise adapted for easy insertion into a cavity plate 80.

Specifically, the cavity sleeve 150 defines an opening 151 that is sized to contain a cavity mold 20. It includes runner 152 to match the runners 40 on the cavity plate 80, and runner 153 to match the runners 25 on the cavity 20. The cavity sleeve 150 also includes lines 154 for coolant circulation around the cavity 20, with coolant inlet 155 and coolant outlet 156. Also included in the cavity sleeve 150 are one or more keys or flats 157 for aligning the cavity in the cavity sleeve, one or more holes 158 for mounting bolts or dowels, and one or more holes 159 for ejector pins (not shown).

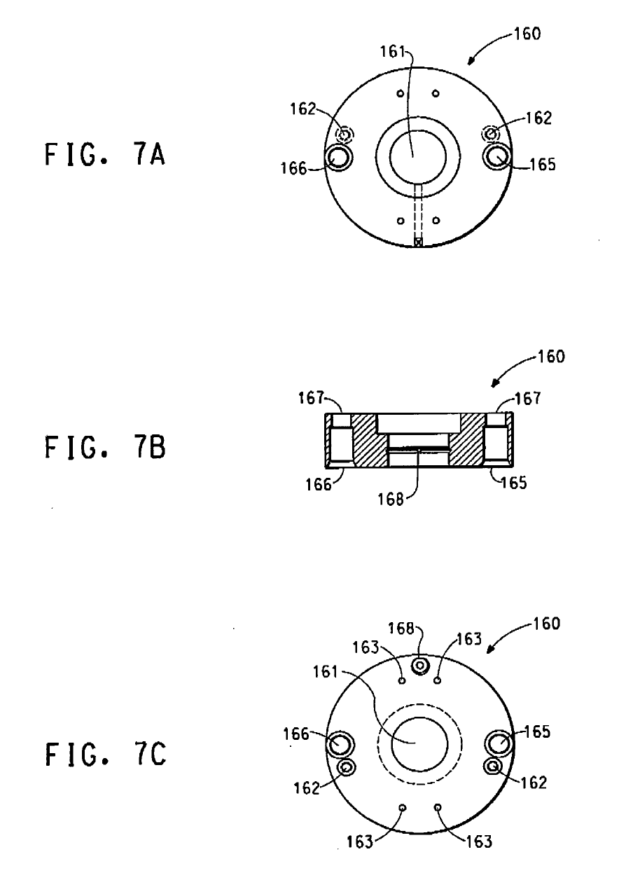

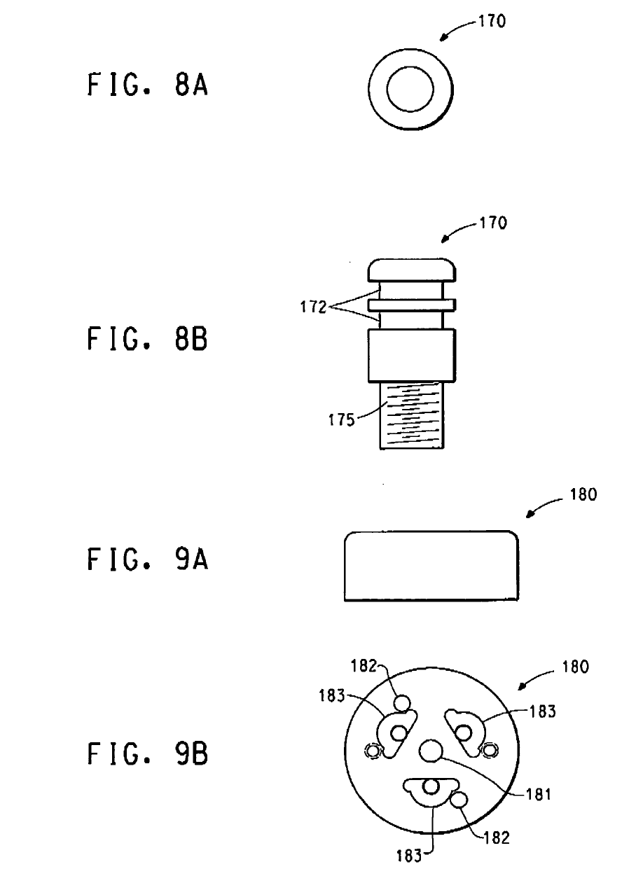

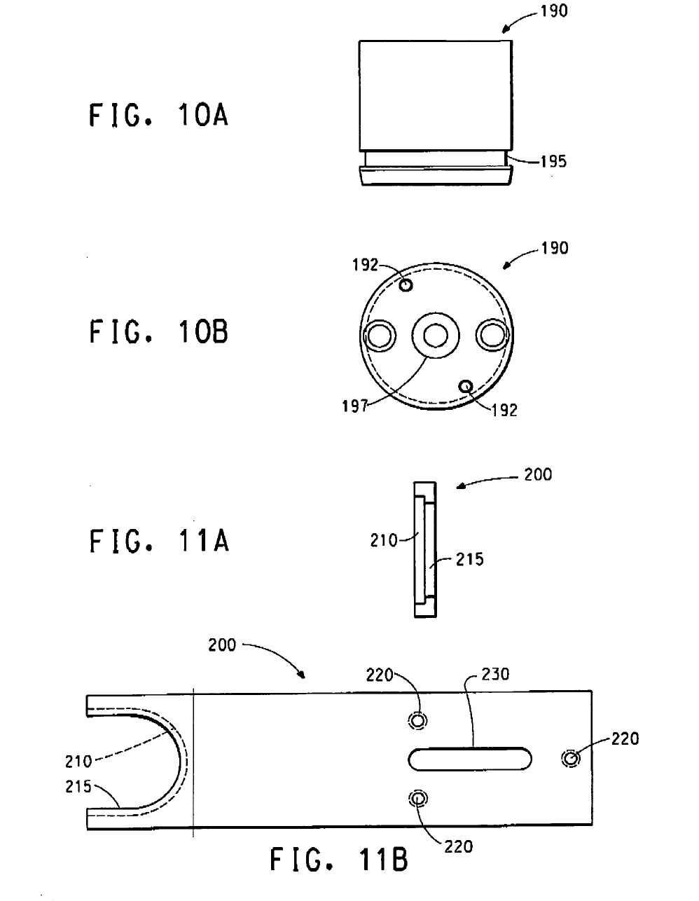

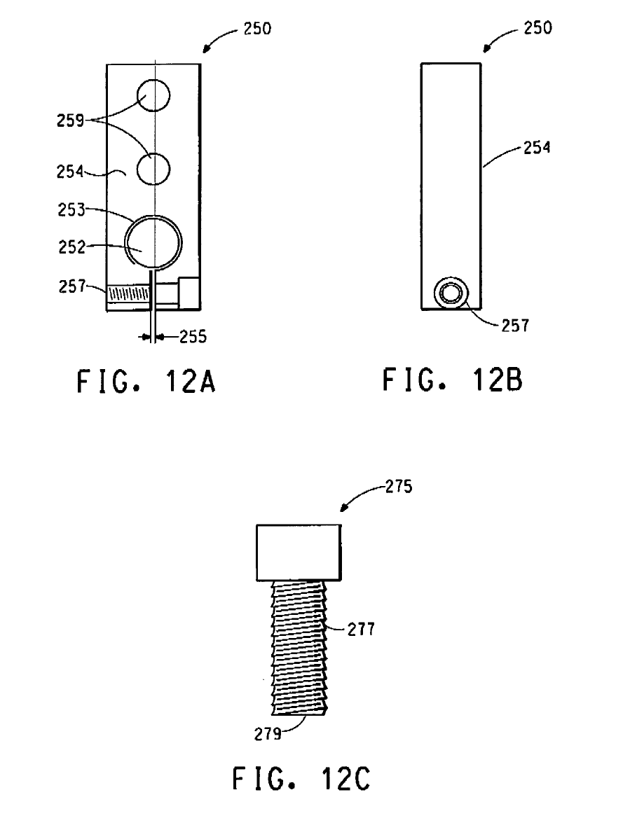

Referring now to FIGS. 7A, 7B, and 7C, a vacuum bushing sleeve 160 is used for attaching the vacuum bushing 110 to the cavity sleeve 150, connecting the vacuum, allowing the runner ejector pins to pass through its body, and allowing coolant to pass through its body to the cavity sleeve 160. The vacuum bushing sleeve 160 includes a hole 161 sized to accommodate the vacuum bushing 110. The outside diameter of the sleeve 160 is smooth or otherwise adapted for easy insertion into a cavity plate 80. The vacuum bushing sleeve 160 includes holes 162 for mounting bolts or dowels, and one or more holes 163 for ejector pins. The vacuum bushing sleeve 160 further includes a coolant inlet 165 and a coolant outlet 166 that are mated to the coolant inlet 155 and outlet 156 of the cavity sleeve 150. The coolant inlet 165 and outlet 166 are provided with grooves 167 for O-rings or other sealing means. A vacuum connection 168 runs through the vacuum bushing sleeve 160 to connect with groove 112 of the vacuum bushing.

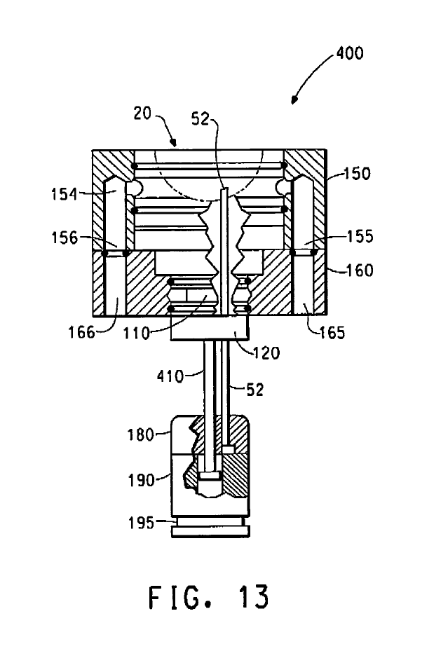

Turning to FIGS. 8A and 8B, a line connection stud 170 is used for quickly and reversibly attaching and removing coolant supply lines and vacuum lines from the mold cartridge of the invention. The stud 170 includes one or more grooves 172 for O-rings, so that the connection of the coolant or vacuum to the cartridge assembly 400 (shown in FIG. 13) is reversible and sealed against leaks. Also included are threads 175 for reversibly connecting the stud 170 to a coolant or vacuum line. The invention is not limited by the design of the line connection stud 170. Any convenient, reversible, and sealable means of connecting coolant or vacuum lines to the cartridge assembly 400 is suitable for use in the invention.

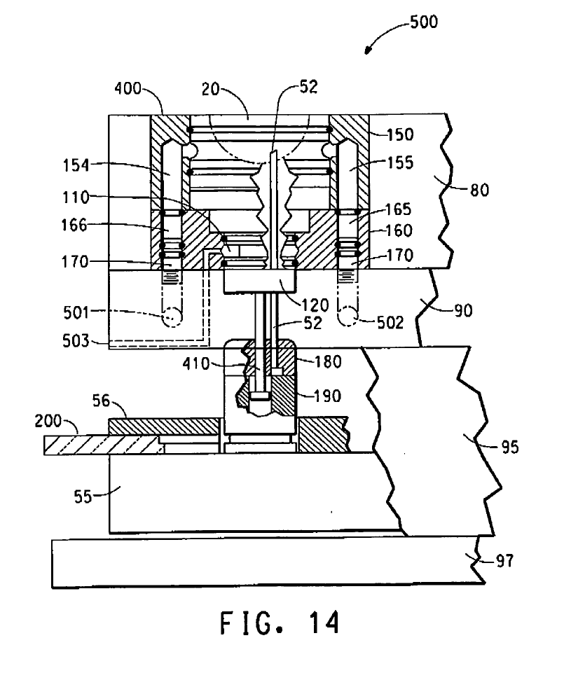

Referring now to FIGS. 9A and 9B, a pin holder 180 of the invention is used to hold the retractable pins 52 in a precise location and orient them in the proper manner for the cavity 20. Devices of this nature have been utilized in retractable pin molds 100 known in the art; however, these prior art devices were locked in the pin retainer plate of the ejector assembly and used the ejector plate 55 as the locating mechanism for the back of the pin. The pin holder 180 of the invention is an independent device that is removably attachable to the ejector plate 55 via a retaining screw that passes through hole 181. One or more dowels 182 align the pins 52 with the holes in the cavity 20. The pins 52 are lodged in pockets 183 with locating flats.

Referring now to FIGS. 10A and 10B, a pin connection block 190 of the invention connects to the pin holder and precisely locates the back of the pins 52 in the manner of the ejector plate 55 described above. One or more dowels 192 ensure alignment with the pin holder 180. It further provides a groove 195 for connection to a securing means and includes a hole 197 for a retaining screw or connector to pass through its body. In the injection molds 100 that are known in the art, the position of the pins 52 is typically fixed so that each mold can accommodate only a single size of core. At best, the pin position is discontinuously adjustable, as with shims, for example. In contrast, the pin holder 180 and pin connection block 190 of the invention permit continuous adjustment of the pin position, thus accommodating a range of core sizes.

Turning to FIGS. 11A and 11B, a locking slide 200 is attached to the ejector plate 55 by box ways, linear bearings, wear plates, or other means so that the slide 200 is free to move horizontally in one axis, but not in a vertical manner. This horizontal movement permits a concave arc 210 on the end of the device to engage the slot 195 of the pin connection block 190. The fit of the arc 210 and the slot 195 is such that the pin connection block 190 is held securely against the ejector plate 55. This may be accomplished, for example, by providing a step 215 in the profile of the arc. The height of the step 215 corresponds to the distance from the bottom of the pin connector block 190 to the slot 195. Ball detent screws or the like prevent unwanted horizontal movement of the slide 200, once it is engaged with the pin connection block 190. Holes 220 for ball detent screws are depicted. The locking slide 200 thus removably attaches the ejector plate to the cartridge assembly 400, and allows the stop blocks 72 and stop pads 76 of the mold base to control the forward and rearward movement of the retractable pins 52 of the cartridge assembly 400.

While the pins 52 can be made of such a length that they will be in the proper rearward position when the ejector plate 55 is in the rearward position, their forward position must be changed to accommodate various core sizes. In the mold assembly of FIG. 1B, the stop blocks 72 must be changed or modified in order to have the pins 52 stop in the proper position of forward movement. For example, in a mold assembly 100 of the prior art, it is necessary to disassemble the mold 100, or to insert one or more shims between the ejector plate 55 and the backup plate 90, or both, in order to adjust the forward position of the pins 52. Thus, the forward position of the pins 52 is not continuously adjustable, and can only be changed with great inconvenience.

Referring now to FIGS. 12A, 12B, and 12C, a stop block 250 allows the forward travel of the pins to be easily and continuously adjustable. One or more stop blocks 250 are used in place of the stop cap 70 of the mold assembly 100. The stop block 250 has a hole 252 formed therein, preferably perpendicularly to the mounting face 254 of the block. The hole 252 is provided with ground or threadmilled threads 253. The threaded hole 252 is split, drilled and tapped through the split to form a gap 255 and a via 257. Via 257 is preferably also threaded. The stop block 250 is also provided with means for mounting to the ejector plate 55. For example, the stop block 250 may be drilled with mounting holes 259. The stop block 250 may be attached to the ejector plate 55 at any point that is convenient. If necessary, the ejector plates 55 may be extended so that the stop block 250 functions outside the perimeter of the cavity plate 80.

Still referring to FIGS. 12A, 12B, and 12C, a stop stud 275 has threads 277 that match the threads 253 of the stop block 250 and a ground end 279 that is perpendicular to the direction of travel of the threads 277. The ground end 279 will engage with the ejector plate 55 of the complementary counterpart mold to define the forward position of the pins 52. A standard screw or bolt passed through via 257 can be used to clamp the stop stud 275 in any location by reducing the width of the gap 255. The stop stud 275 replaces the stop blocks 72 of the mold 100. Once the required movement of the ejector plate 55 for the forward position of the pins 52 is known, a spacer such as a gauge block or feeler gauge can be placed between the ejector plate 55 and the stop stud 275. The stop stud 275 is unclamped and rotated until contact is made with the spacer, and the stop stud 275 is again clamped. Once all the stop blocks 250 are adjusted, the mold assembly 500 is ready to run the new core size.

Referring now to FIG. 13, a quick change cartridge assembly 400 of the invention comprises a cavity 20 surrounded by and removably connected to a cavity sleeve 150. The cavity 20 is removably connected to a vacuum bushing 110, which, in turn, is removably connected to a vacuum bushing cap 120. The vacuum bushing 110 is surrounded by and removably connected to a vacuum bushing sleeve 160. One or more core holding pins 52 extend from the cavity 20 to a pin holder 180. The pin holder 180 is connected to a pin connection block 190 and to the vacuum bushing cap 120 by a retaining screw 410. The cartridge assembly 400 also includes a plurality of O-rings, shown in cross section as pairs of solid circles, for maintaining seals against vacuum or coolant leaks.

Notably, quick change cartridge assembly 400 includes most of the features of the prior art mold 100. FIG. 13 shows that the cavity 20 locked in place, the vacuum bushing assembly 110, 120, and 160 is locked in place, there are provisions for vacuum and coolant, and the retractable pins 52 are in place and free to move, albeit without positive forward and rearward stops.

Referring now to FIG. 14, in a mold assembly 500 that is a preferred embodiment of the current invention, the quick change cartridge assembly 400 is connected to the coolant inlet line 501, coolant outlet line 502, and vacuum line 503 through the cavity plate 90 of the mold. The locking slide 200 is shown ready to reversibly engage the pin connection block 190. When the locking slide 200 is engaged, the pins 52 are locked to the pin plate 56 and can move with the ejector plate 55. When the locking slide 200 is disengaged, the entire cartridge assembly 400 may be detached from the mold assembly 500 by removing the mounting bolts from the holes 158 on the face of the cavity sleeve 150. Conversely, a cartridge assembly 400 may be inserted into the mold assembly 500 and secured by engaging the locking slide 200 and tightening the mounting bolts in their holes 158.

Significantly, in the mold assembly 500 of the invention, any component in a cartridge assembly 400 can be replaced without impacting the use in production of the other cartridge assemblies 400 in the mold. This attribute is efficient and economical when it is necessary to change the size of the cavity, or to replace a damaged part in the cartridge assembly 400. Also significantly, the removable cartridges 400 do not sacrifice conventional features such as circulating lines 154 for cooling medium around the cavity 20 and vacuum lines 503 to assist in drawing the thermoplastic material into the cavity 20. By comparison, in the mold assembly 100 of the prior art, the entire mold must be disassembled in order to change or replace any part of the cavity 20, vacuum bushing 110, pins 52, or pin holder 57.

The encapsulation mold assembly 500 and interchangeable cartridge 400 of the invention may advantageously be used in conjunction with the apparatus and methods described in copending U.S. Appln. No. 60/604,332, filed on Aug. 25, 2004. Specifically, the molten thermoplastic material may be delivered to the cavity 20 and/or cavity sleeve 150 through runners 40 that are radius flow channels. Radius flow channels promote laminar flow in the runners 40 by avoiding dead spots, high-shear sharp corners, and other turbulent areas in the path of the molten thermoplastic material. The tendency to form “hot spots”, where a portion of the molten thermoplastic material may linger and develop a different thermal history from the bulk, is thus decreased. Preferably, the runners 40 have a diameter such that the shear experienced by the molten thermoplastic material during the course of an injection molding operation is less than or equal to about 1000 sec⁻¹.

In addition, the encapsulation mold assembly 500 and the runners 40 may be heated and controlled to within 20° F. of the process temperature used for the molten thermoplastic material. Still further, the encapsulation mold assembly 500 and the runners 40 may be heated using heaters. Preferably, in order to avoid the creation of “hot spots”, the heaters are placed such that then do not cross over the runners 40.

The encapsulation mold assembly 500 may also be equipped with valve gates to shut off the flow of polymer to the cavity 20 and/or cavity sleeve 150 and thus minimize polymer trim for disposal or recycling.

Thus, in a process for manufacturing a layered article in a retractable pin injection mold, a thermoplastic material is heated to a processing temperature at which it can flow through the runners 40 in an encapsulation mold assembly 500; the encapsulation mold assembly 500 and the runners 40 are provided with heaters; the heaters preferably do not cross the runners 40; the runners 40 are radius flow channels; the runners 40 are preferably sized such that the shear experienced by the thermoplastic polymer is less than or equal to 1000 sec⁻¹; the encapsulation mold assembly 500 may optionally comprise valve gates; the temperature of encapsulation mold assembly 500 and the runners 40 is controlled within a range of from about 20° F. less than the polymer processing temperature to about 20° F. greater than the processing temperature.

The description herein has been specifically exemplified and illustrated by molds for manufacturing spherical objects, such as golf balls. It is apparent, however, that the structures and methods described herein will apply to the manufacture of any layered object or precursor core, whether spherical or not, wherein the precursor core needs to be positioned in an injection mold to receive a covering layer of thermoplastic material.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A pin connection block comprising a groove for engaging with a locking slide and means for attachment to a pin holder of a retractable pin injection mold assembly.

2. The pin connection block of claim 1, wherein the means for attachment comprises a retaining screw or bolt.

3. A locking slide connected to an ejector plate of a retractable pin injection mold assembly, said locking slide having a structure that is mated for engaging with a groove on a pin connection block.

4. The locking slide of claim 3, wherein the structure is a concave arc.

5. A system for reversibly attaching a pin connection block to an ejector plate, said system comprising the locking slide of claim 3 and the pin connection block of claim 1.

6. A stop block comprising a mounting face; means for mounting the stop block on a mold assembly; a threaded hole for a stop stud, said threaded hole being split to form a gap; and a via for a locking means, said via formed through the gap.

7. The stop block of claim 6, wherein the threaded hole for the stop stud is perpendicular to said mounting face.

8. The stop block of claim 6, wherein the via is threaded and the locking means comprises a screw or bolt.

9. The stop block of claim 6, wherein the mounting means comprises holes for mounting screws or bolts.

10. A system for continuously adjusting the forward position of pins, comprising the stop block of claim 6 mounted on a mold assembly and a surface on a complementary counterpart mold assembly against which the stop stud rests when the mold assembly and the complementary counterpart mold assembly are engaged.

11. The system of claim 10, wherein the stop block is mounted on the ejector plate of the mold assembly, and the stop stud rests on the ejector plate of the complementary mold assembly, when the mold assembly and the complementary counterpart mold assembly are engaged.

12. A cavity sleeve for a retractable pin injection mold assembly comprising an opening that is sized to accommodate a cavity; one or more runners to connect a runner in a cavity plate to a runner in the cavity; an inlet, an outlet, and a line for circulating coolant; one or more holes for accommodating vent pins or core positioning pins; means for aligning the cavity; and means for mounting the cavity sleeve to the cavity plate; wherein the inlet and outlet are formed in the side of the cavity sleeve that is opposite to the cavity.

13. The cavity sleeve of claim 12, wherein the means for aligning the cavity comprise one or more keys or flats; or wherein the means for mounting the cavity sleeve to the cavity plate includes one or more holes for mounting bolts or dowels.

14. A cartridge assembly comprising a cavity; a cavity sleeve of claim 12; a vacuum bushing having a vacuum groove; a vacuum bushing sleeve having an inlet and an outlet for circulating coolant, wherein the inlet and outlet of the vacuum bushing sleeve are mated to the inlet and outlet of the cavity sleeve, and a vacuum connection that is mated to the vacuum groove of the vacuum bushing, and further wherein; one or more vacuum bushing caps; one or more core positioning pins; one or more vent pins; a pin holder; and a pin connection block removably attached to the vacuum bushing cap.

15. A mold assembly comprising the cartridge of claim 14.

16. The mold assembly of claim 15, further comprising the stop block of claim 6.

17. The mold assembly of claim 15, wherein one or more of the runners is a radius flow channel.

18. The mold assembly of claim 15, wherein one or more of the runners has a diameter such that the shear experienced by a molten thermoplastic material during the course of an injection molding operation is less than or equal to about 1000 sec⁻¹.

19. The mold assembly of claim 15, further comprising one or more heaters.

20. The mold assembly of claim 19, wherein the heaters do not cross the runners.

21. The mold assembly of claim 15, further comprising one or more valve gates.

22. A process for injection molding a layered article comprising a thermoplastic material, said process comprising the steps of
providing a mold assembly of claim 15; and
maintaining the temperature of the mold assembly or the runners within a range of from about 20° F. less than the polymer processing temperature to about 20° F. greater than the processing temperature of the molten thermoplastic material.

23. A system for changing cavities in a retractable pin injection molding assembly, comprising the cartridge assembly according to claim 14, and the system of claim 5 for reversibly attaching a pin connection block to an ejector plate.
